(19) United States
(12) Patent Application Publication
(10) Pub. No.: US 2012/0006204 A1
(43) Pub. Date: Jan. 12, 2012

(54) MODULAR VENDING MACHINE AND CARTRIDGE SYSTEM

(75) Inventors: Michael Eidenschink, Miami, FL (US); Tarcisio Vergani, Wiltshire (GB); Matthew Hooper, Bristol (GB)

(73) Assignee: CRANE MERCHANDISING SYSTEMS, INC., Bridgeton, MO (US)

(21) Appl. No.: 13/179,065

(22) Filed: Jul. 8, 2011

Related U.S. Application Data
(60) Provisional application No. 61/362,798, filed on Jul. 9, 2010.

(51) Int. Cl. A47J 31/44; B67D 7/74

(52) U.S. Cl. 99/279; 222/129.1; 206/219

(57) ABSTRACT

A refillable vend module includes at least one canister configured to contain an ingredient for a beverage, and a connecting mechanism configured to slidably connect to any one of a plurality of modular vend spaces in a vending machine. In some embodiments, the at least one canister comprises a poka-yoke refill connection configured to couple an ingredient cartridge to the canister, where the poka-yoke refill connection matches a type of the canister to a type of the ingredient cartridge. A vending machine includes a plurality of modular vend spaces and a plurality of refillable vend modules.

### CROSS-REFERENCE TO RELATED APPLICATION(S) AND CLAIM OF PRIORITY

The present application claims priority to commonly assigned U.S. Provisional Patent Application No. 61/362,798, filed Jul. 9, 2010, entitled “MODULAR VENDING MACHINE AND CARTRIDGE SYSTEM”, which is hereby incorporated by reference into the present application as if fully set forth herein.

### TECHNICAL FIELD

The present disclosure is directed, in general, to vending machines, and more specifically, to a modular vending machine and a modular canister cartridge system for use in the modular vending machine.

### BACKGROUND

Merchandising systems or “vending machines” have long been used to sell products. For example, vending machines are often used to sell beverages and snacks in schools, workplaces, and cafeterias. Vending machines that sell beverages may dispense beverages in pre-packaged containers (e.g., bottles or cans of soda) or may dispense unpackaged beverages into an open container (e.g., coffee into a cup). Some vending machines may be capable of dispensing both pre-packaged and unpackaged beverages. Vending machines that sell unpackaged beverages typically contain ingredients that are mixed with liquid from another source to produce the vended beverages.

Conventional vending machines are typically pre-configured at the time of sale or manufacture to dispense only certain types of beverages. To accommodate new sales trends or new product lines, such vending machines have to be substantially reconfigured, requiring significant man-power, tools, and machine downtime.

Thus, there is a need in the art for a highly-configurable, modular vending machine.

### SUMMARY

According to one embodiment of the present disclosure, a refillable vend module includes at least one canister configured to contain an ingredient for a beverage. The refillable vend module also includes a connecting mechanism configured to slidably connect to any one of a plurality of modular vend spaces in a vending machine.

In another embodiment, a vending machine includes a plurality of modular vend spaces, and a plurality of refillable vend modules. Each vend module includes at least one canister configured to contain an ingredient for a beverage, and a connecting mechanism configured to slidably connect to any of the modular vend spaces.

In still another embodiment, a method of operating a vending machine includes connecting a plurality of refillable vend modules to a plurality of modular vend spaces in the vending machine by slidably connecting a connecting mechanism of each vend module to any one of the modular vend spaces. Each vend module includes at least one canister configured to contain an ingredient for a beverage.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates three views of a beverage vending machine suitable for dispensing hot and cold beverages, according to an embodiment of this disclosure;

FIG. 2 illustrates a block diagram and a second drawing of a vending machine according to an embodiment of this disclosure;

FIG. 3 illustrates three configurations of a vend module according to an embodiment of this disclosure;

FIG. 4 illustrates views of a vend module from two different angles, according to an embodiment of this disclosure;

FIGS. 5A through 5C illustrate a modular canister fill system for a vend module, according to an embodiment of this disclosure; and

FIG. 6 illustrates two views of a dispense head module according to an embodiment of this disclosure.

### DETAILED DESCRIPTION

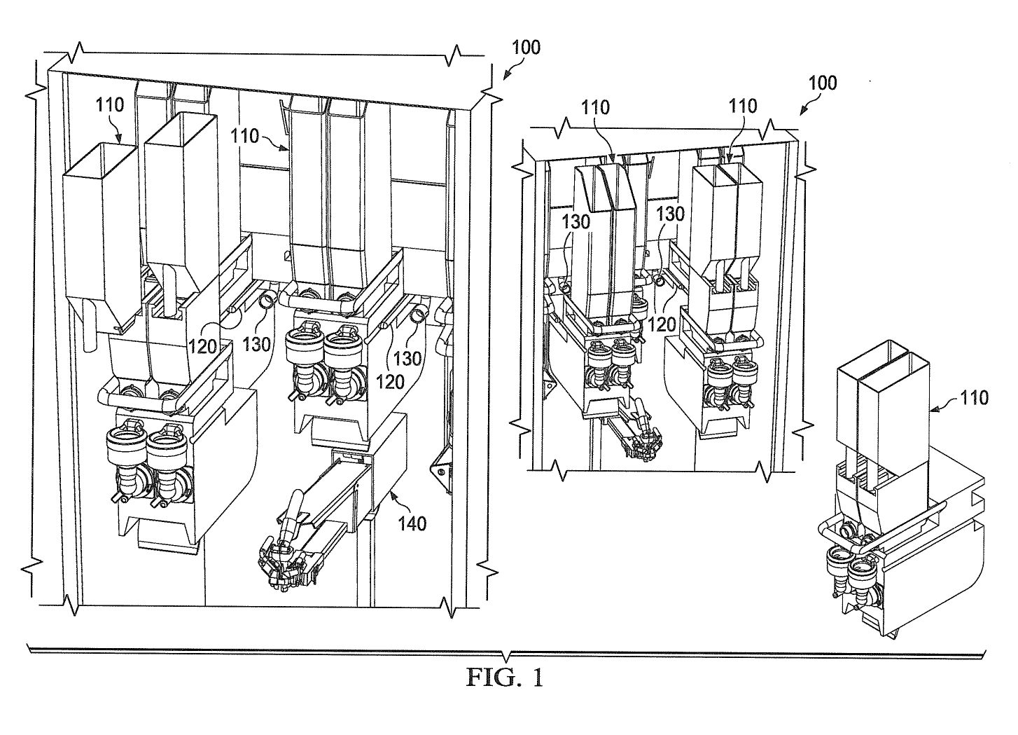

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine.

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention.

This disclosure describes a modular vending machine and a modular canister cartridge system for use in the vending machine. The modular canister cartridge system and associated modular vending machine according to this disclosure solve many of the problems found in conventional canisters and vending machines. A disclosed canister cartridge features a quick fill system that greatly simplifies refilling, and may reduce filling time by 40%-50%. In certain embodiments, a Kanban management system may be used for refilling the cartridge.

The disclosed vending machine and canister cartridge represent a true plug-and-play system, made of simple building blocks, and easily configurable. The vending machine automatically recognizes each module, every product in each module, and all recipes associated with each module. Additional programming is typically not needed.

On-site maintenance of the disclosed vending machine may be eliminated or reduced to a minimum. Because the modules are interchangeable, few or no tools are required to install. Likewise, spare parts are reduced to a minimum.

Other features of the disclosed vending machine and cartridge include:
Stand-by power consumption substantially equal to zero Kw/h due to a flash heater with electricity accumulator
Self diagnostic characteristics
Product delivery via an ingredient cartridge system

FIG. 1 illustrates three views from different angles of a beverage vending machine suitable for dispensing hot and cold beverages, according to an embodiment of this disclosure. The embodiment of vending machine 100 shown in FIG. 1 is for illustration only. Other embodiments of vending machine 100 could be used without departing from the scope of this disclosure.

Vending machine 100 includes one or more canister cartridges 110 (also referred to as vend modules), guide rails 120, a manifold inlet 130, and a dispense head module 140. Guide rails 120 are disposed on a slide-in-place modular rack on a rear panel of the cabinet. Each vend module 110 is configured to securely engage with guide rails 120. For example, during installation or maintenance, slots or grooves on vend module 110 are aligned with associated guide rails 120 and pushed into position until a release catch associated with either vend module 110 or guide rails 120 “clicks” or engages into a secured position in the modular rack. In other embodiments, guide rails 120 and the slots that the rails engage with could be reversed. In other words, the guide rails 120 could be disposed on the sides of vend module 110 (instead of vending machine 100) and the associated slots could be disposed on vending machine 100 (instead of vend module 110). In still other embodiments, other slidably engaging connecting mechanisms could be used in place of guide rails 120 and slots.

Dispense head module 140 is configured to dispense contents from vend modules 110 to a user or customer of vending machine 100. In some embodiments, dispense head module 140 is installed in a box, niche, or compartment in vending machine 100, as shown in FIG. 1. In such embodiments, a release lever, as found on certain types of mixer modules, or a similar connection system, allows the whole dispense head module 140 to be removed from vending machine 100. Manifold inlet 130 is a one-piece manifold that links an inlet of each vend module 110 to one or more mixers, a boiler or hot water source, and any other suitable components.

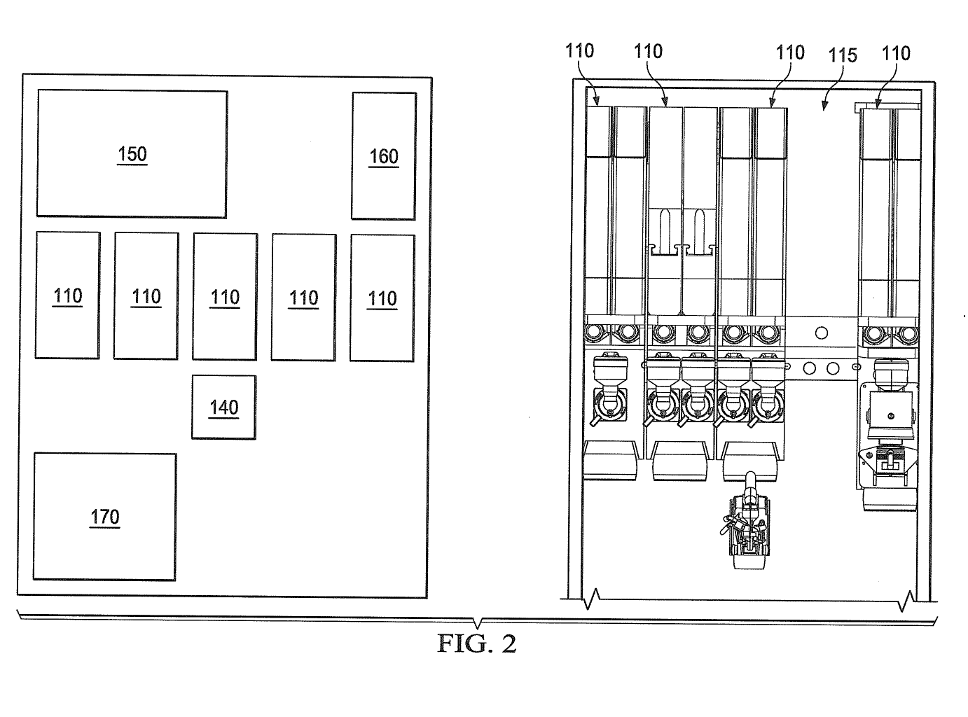

FIG. 2 illustrates a block diagram and a second drawing of vending machine 100, according to an embodiment of this disclosure. The embodiment of vending machine 100 shown in FIG. 2 is for illustration only. Other embodiments of vending machine 100 could be used without departing from the scope of this disclosure.

As shown in the block diagram, vending machine 100 further includes a boiler module 150, a polysulfone (PSU) module 160, and a cold unit module 170. The drawing in FIG. 2 illustrates four vend modules 110 installed in vending machine 100 with an empty space 115 available for a fifth vend module. It will be understood that a vending machine with space for five vend modules is just one example. Other vending machines according to this disclosure may support more or fewer vend modules.

Although FIGS. 1 and 2 depict examples of a vending machine 100, various changes may be made to vending machine 100. For example, in some embodiments, vending machine 100 may include more or fewer vend modules 110 and may include more than one dispense head module 140 for different types of beverages. As another example, other components of vending machine 100 (e.g., manifold inlet 130, boiler module 150, cold unit module 170, etc.) may be combined, separated, added, removed, or arranged in different configurations.

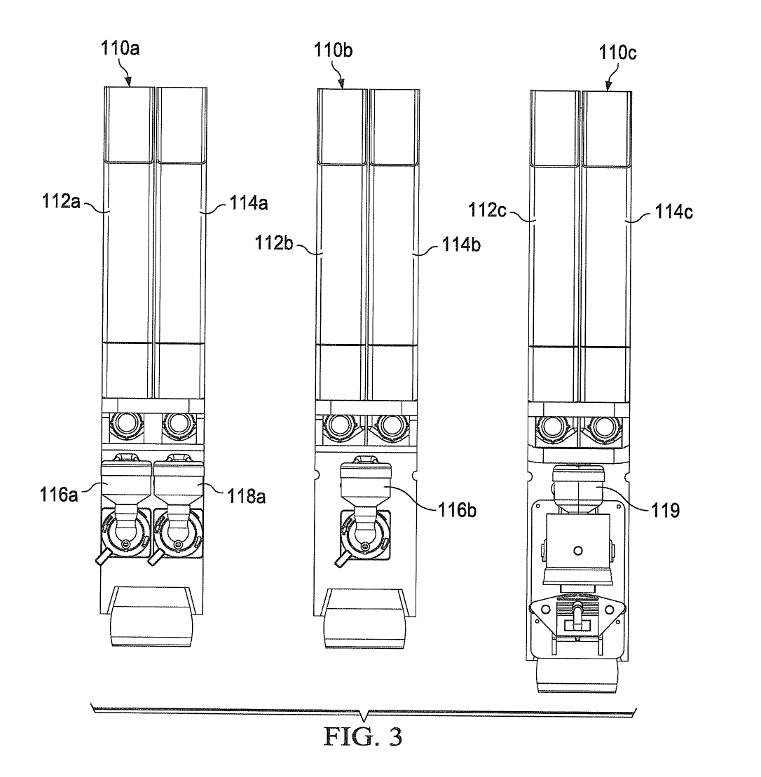

FIG. 3 illustrates three configurations of vend module 110 according to an embodiment of this disclosure. The embodiments of vend module 110 shown in FIG. 3 are for illustration only. Other embodiments of vend module 110 could be used without departing from the scope of this disclosure. Also, for ease of explanation, the embodiments of vend module 110 are described with respect to vending machine 100 of FIG. 1. However, embodiments of vend module 110 could be used with any other suitable vending machine.

Vend module 110a is an instant double-canister module that includes two canisters 112a, 114a and two mixers 116a, 118a. Each mixer 116a, 118a is associated with one canister 112a, 114a and serves to mix contents from the canister 112a, 114a with hot or cold liquid. Vend module 110a can be used for dispensing two different products, such as two instant coffee flavors.

Vend module 110b is an instant double-canister-to-one module that includes a single mixer 116b with twin canisters 112b, 114b, each canister containing a different product. Vend module 110b may be used for dispensing a mixed product, such as an instant mocha coffee beverage. For an instant mocha coffee beverage, mixer 116b receives coffee from one canister (e.g., canister 112b) and chocolate from the other canister (e.g., canister 114b) and mixes the coffee and chocolate with a hot or cold liquid to create the mocha coffee beverage.

Vend module 110c includes one or two canisters 112c, 114c and a brewer 119 for producing fresh brewed (instead of instant) products, such as fresh brewed coffee or tea. Canisters 112c, 114c may contain dry ingredients for brewing, such as coffee grounds or ground tea leaves. Brewer 119 receives the dry ingredients from one or both canisters 112c, 114c and brews the brewed product, e.g., by filtering hot liquid through the dry ingredients.

Although each of the three vend modules 110a-110c has different components, each module is configured to be interchangeable on a standard footprint. Thus, any of the three vend modules 110a-110c could be installed in any empty module space in vending machine 100. For example, in one configuration, vending machine 100 could include two instant double-canister modules (i.e., vend module 110a), two instant double-canister-to-one modules (i.e., vend module 110b), and one brewer module (i.e., vend module 110c). In another embodiment, vending machine 100 could include four instant double-canister modules, one instant double-canister-to-one modules, and no brewer module. Changes can be readily made by removing one module and installing another module. In one embodiment of vending machine 100, up to ten vend modules 110 may be fitted into the cabinet.

Although FIG. 3 depicts three configurations 110a-110c of a vend module 110, various changes may be made to vend module 110. For example, in some embodiments, vend module 110 may include a single canister module, a larger single canister that occupies two or more module spaces, a bean-to-cup (B2C) module, a boiler module, a dispense head module, a power supply module, a cold unit module, and any other suitable module. A B2C module includes a grinder to grind fresh coffee beans; the coffee is then brewed immediately after grinding.

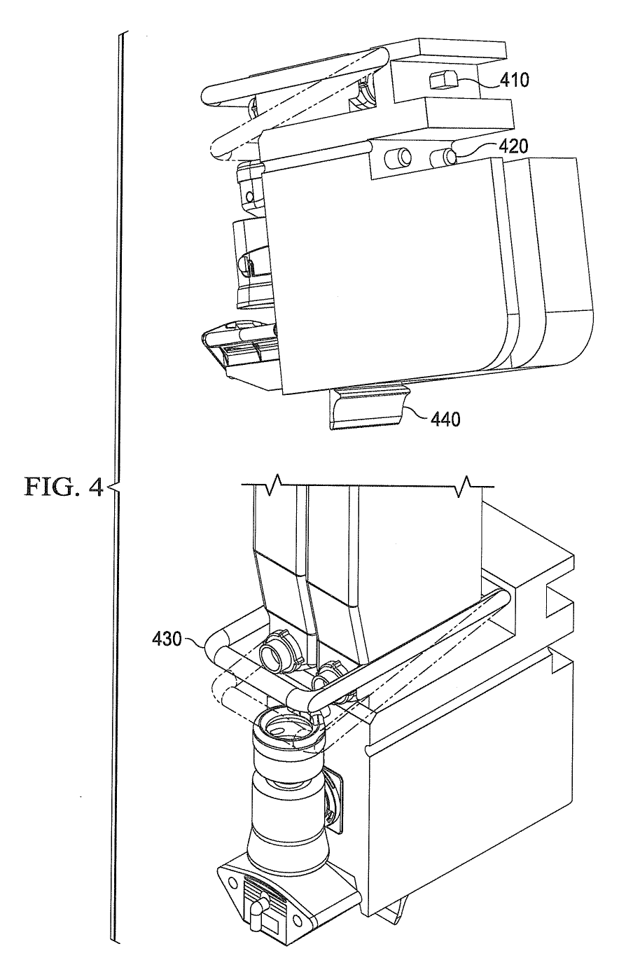

FIG. 4 illustrates views of a vend module 110 from two different angles, according to an embodiment of this disclosure. The embodiments of vend module 110 shown in FIG. 4 are for illustration only. Other embodiments of vend module 110 could be used without departing from the scope of this disclosure.

On its reverse side, vend module 110 includes electrical connection 410 and water connection 420. Electrical connection 410 is a male connector configured to provide power to a vend motor or other electrical device in vend module 110. Water connection 420 includes two push fit inlets. The inlets are equally spaced on each module 110 to allow any combination of mixers and any arrangement of vend modules 110 in vending machine 100. In certain embodiments, water connection 420 fits into manifold inlet 130, which contains all water channels. Both electrical connection 410 and water connection 420 are self-engaging connections.

On its obverse side, vend module 110 includes grab handle 430. Grab handle 430 can be lowered or otherwise actuated to allow for easy removal of vend module 110 from vending machine 100. Grab handle 430 may also provide support for vend module 110 when the entire module is removed. Vend module 110 also includes release lever 440.

In certain embodiments, vend module 110 includes one or more RFID (radio frequency identification) tags that are readable by a RF reader in, or associated with, vending machine 100. The RFID tag provides information about vend module 110, such as the quantity and type of contents of vend module 110. Thus, RFID integration between vending machine 100 and vend module 110 may be used, for example, to ensure that vend module 110 is installed in a correct module space in vending machine 100 in order to dispense a correct product based on a customer selection. In addition, RFID communication between vending machine 100 and vend module 110 may provide information to an operator when vend module 110 is almost empty. Likewise, product counters in vend module 110 or vending machine 100 may be used to track dispensed products, thus providing an additional or alternative way to track inventory of vend module 110.

As explained previously, vend module 110 and vending machine 100 together provide a plug-and-play system that is easier to configure that conventional vending machines. As each vend module 110 is installed in vending machine 100, a controller in, or associated with, vending machine 100 reads data or software from a memory in vend module 110. The data or software includes information related to products, recipes, or temperature for vend module 110.

Although FIG. 4 depicts one example of vend module 110, various changes may be made to FIG. 4. For example, in some embodiments, any or all of electrical connection 410, water connection 420, grab handle 430, and release lever 440 may be removed, changed, or arranged in other configurations.

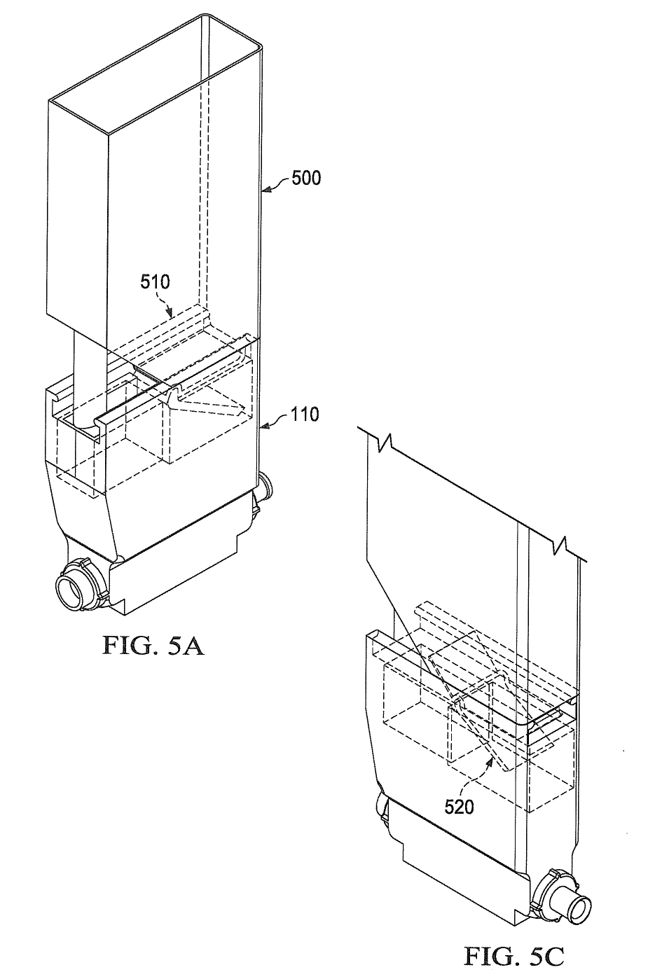

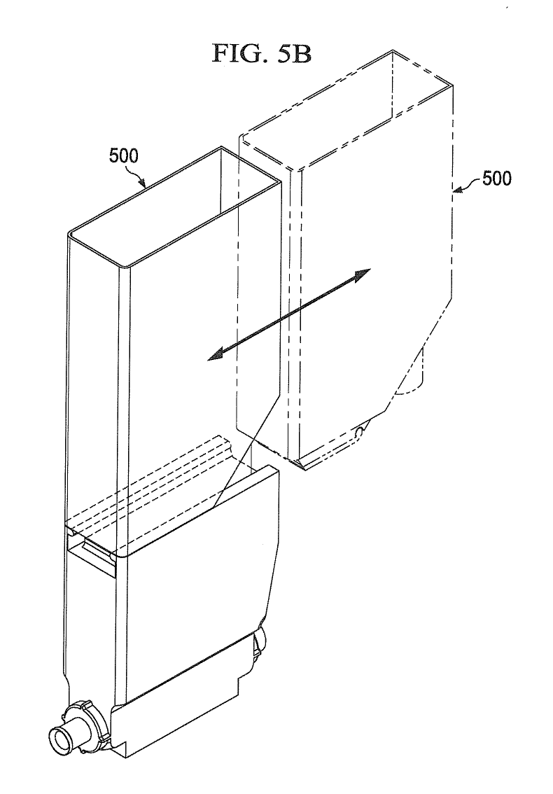

FIGS. 5A through 5C illustrate a modular canister fill system for vend module 110, according to an embodiment of this disclosure. The embodiments of the modular canister fill system shown in FIGS. 5A through 5C are for illustration only. Other embodiments of a modular canister fill system could be used without departing from the scope of this disclosure.

As shown in FIG. 5A, an ingredient cartridge 500 is fitted on top of the canister of vend module 110. Ingredient cartridge 500 is configured to refill vend module 110 when vend module 110 is empty or nearly empty. Ingredient cartridge 500 and vend module 110 include a poka-yoke connection 510 that is configured for easy coupling and de-coupling of ingredient cartridge 500 with vend module 110. A unique rail design or shape on poka-yoke connection 510 is associated with each type of ingredient cartridge 500. For example, one rail shape may be associated with instant coffee. Another rail shape may be associated with fresh brewed coffee. In one embodiment, it is not possible to install an ingredient cartridge having one rail shape on a vend module with a different rail shape. Thus, the unique rail designs help to ensure that the correct type of ingredient cartridge 500 is installed on vend module 110.

FIGS. 5B and 5C illustrate an installation of ingredient cartridge 500 onto vend module 110. Ingredient cartridge 500 engages with canister rails 510 and slides into place, as shown in FIG. 5B. As it slides, a cartridge door 520 is opened and a product is fed into the canister of vend module 110, as shown in FIG. 5C. When ingredient cartridge 500 is installed on vend module 110, the cartridge door 520 and product delivery passage are not exposed to the surrounding environment. The closed nature of this system helps to prevent dust or other foreign matter from getting in and contaminating vend module 110 and vending machine 100.

It is noted that: the embodiment of vend module 110 depicted in FIGS. 5A-5C may appear different than the embodiments of vend module 110 shown in FIGS. 1-4. However, it will be understood that vend module 110 depicted in FIGS. 5A-5C may represent embodiments of vend module 110 in FIGS. 1-4.

Although FIGS. 5A through 5C depicts one example of a modular canister fill system, various changes may be made to FIGS. 5A through 5C. For example, in some embodiments, poka-yoke connection 510 may include slots, notches, grooves, or other design elements configured to create unique rail shapes for each type of ingredient cartridge 500.

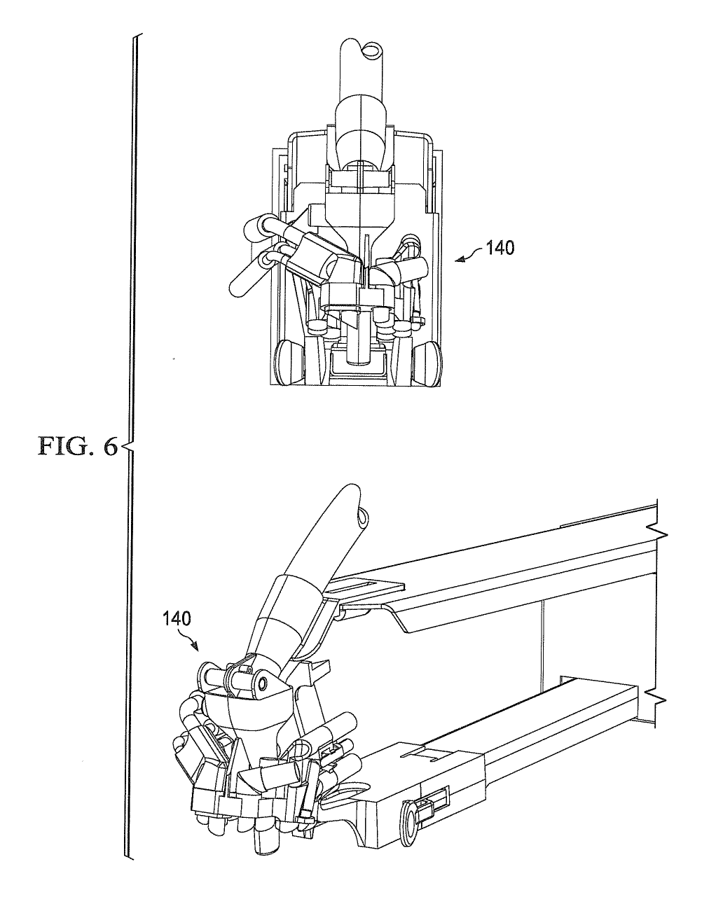

FIG. 6 illustrates two views of dispense head module 140 according to an embodiment of this disclosure. The embodiment of dispense head module 140 shown in FIG. 6 is for illustration only. Other embodiments of dispense head module 140 could be used without departing from the scope of this disclosure. Also, for ease of explanation, the embodiment of dispense head module 140 is described with respect to vending machine 100 of FIG. 1. However, embodiments of dispense head module 140 could be used with any other suitable vending machine.

Dispense head module 140 is a quick release dispense head. Dispense head module 140 includes levers attached to its frame. To remove dispense head module 140 from an installed position in vending machine 100, an operator simply squeezes the levers and pulls module 140 away from vending machine 100. To install dispense head module 140, the operator simply pushes the module into place until the levers “click” or engage into a secured position.

Although FIG. 6 depicts one example of dispense head module 140, various changes may be made to FIG. 6. For example, in some embodiments, dispense head module 140 may include buttons, tabs, or other structures instead of, or in addition to, levers.

In accordance with the embodiments described above, this disclosure features an easily configurable vending machine and vend module. The vending machine automatically recognizes each module, every product in each module, and all recipes associated with each module. This allows the vending machine operator to quickly and easily adapt the vending machine to react to sales trends, suit local preferences, and offer or promote new products.

Although the figures above illustrate specific systems, structures, and methods, various changes may be made to the figures. For example, various components in the systems and structures can be combined, omitted, further subdivided, or moved according to particular needs. In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A refillable vend module comprising:
at least one canister configured to contain an ingredient for a beverage; and
a connecting mechanism configured to slidably connect to any one of a plurality of modular vend spaces in a vending machine.

2. The refillable vend module of claim 1, wherein the at least one canister comprises a poka-yoke refill connection configured to couple an ingredient cartridge to the canister, the poka-yoke refill connection matching a type of the canister to a type of the ingredient cartridge.

3. The refillable vend module of claim 1, wherein the connecting mechanism comprises slots that engage with guide rails of the vending machine.

4. The refillable vend module of claim 1, further comprising:
an electrical connection; and
a water connection configured to couple to a manifold of the vending machine.

5. The refillable vend module of claim 1, further comprising:
at least one mixer configured to mix a liquid with the at least one ingredient.

6. The refillable vend module of claim 5, wherein the at least one canister comprises first and second canisters and the at least one mixer comprises one mixer, the mixer configured to mix the ingredient from the first canister with the ingredient from the second canister.

7. The refillable vend module of claim 1, further comprising:
a brewer configured to brew a hot beverage by passing a liquid through the at least one ingredient.

8. A vending machine for dispensing beverages comprising:
a plurality of modular vend spaces; and
a plurality of refillable vend modules, each vend module comprising:
at least one canister configured to contain an ingredient for a beverage; and
a connecting mechanism configured to slidably connect to any of the modular vend spaces.

9. The vending machine of claim 8, wherein the at least one canister of each vend module comprises a poka-yoke refill connection configured to couple an ingredient cartridge to the canister, the poka-yoke refill connection matching a type of the canister to a type of the ingredient cartridge.

10. The vending machine of claim 8, wherein the connecting mechanism of each vend module comprises slots that engage with guide rails of the vending machine.

11. The vending machine of claim 8, each vend module further comprising:
an electrical connection; and
a water connection configured to couple to a manifold of the vending machine.

12. The vending machine of claim 8, each vend module further comprising:
at least one mixer configured to mix a liquid with the at least one ingredient.

13. The vending machine of claim 12, wherein the at least one canister of at least one vend module comprises first and second canisters and the at least one mixer comprises one mixer, the mixer configured to mix the ingredient from the first canister with the ingredient from the second canister.

14. The vending machine of claim 8, wherein at least one vend module further comprises:
a brewer configured to brew a hot beverage by passing a liquid through the at least one ingredient.

15. The vending machine of claim 8, further comprising:
a quick release dispense head module configured to dispense the beverage from at least one of the vend modules.

16. A method of operating a vending machine, the method comprising:
connecting a plurality of refillable vend modules to a plurality of modular vend spaces in the vending machine by slidably connecting a connecting mechanism of each vend module to any one of the modular vend spaces,
wherein each vend module comprises at least one canister configured to contain an ingredient for a beverage.

17. The method of claim 16, further comprising:
refilling the at least one canister of each vend module by coupling an ingredient cartridge to the canister using a poka-yoke refill connection, the poka-yoke refill connection matching a type of the canister to a type of the ingredient cartridge.

18. The method of claim 16, wherein the connecting mechanism of each vend module comprises slots that engage with guide rails of the vending machine.

19. The method of claim 16, further comprising:
electrically connecting each vend module to the vending machine; and
coupling a water connection of each vending machine to a manifold of the vending machine.

20. The method of claim 16, further comprising:
at each vend module, mixing a liquid with the at least one ingredient using at least one mixer in the vend module.

21. The method of claim 20, wherein the at least one canister of at least one vend module comprises first and second canisters and the at least: one mixer comprises one mixer, the method further comprising:
mixing the ingredient from the first canister with the ingredient from the second canister using the mixer.
